(19) United States
(12) Patent Application Publication
(10) Pub. No.: US 2018/0169674 A1
(43) Pub. Date: Jun. 21, 2018

(54) VORTEX-GENERATING WASH NOZZLE ASSEMBLIES

(71) Applicant: VOLKREN CONSULTING INC., Calgary (CA)

(72) Inventor: Scott VANDER VELDE, Calgary (CA)

(21) Appl. No.: 15/736,694

(22) PCT Filed: Jun. 27, 2016
(86) PCT No.: PCT/CA2016/050751

§ 371 Date: Dec. 14, 2017

Related U.S. Application Data
(60) Provisional application No. 62/185,331, filed on Jun. 26, 2015.

(51) Int. Cl. B05B 1/34; B05B 1/06; B05B 1/08; B05B 1/16; B08B 9/043

(52) U.S. Cl. CPC B05B 1/3405; B05B 1/06; E21B 37/08; B05B 1/1609; B08B 9/0433; B05B 1/08

(57) ABSTRACT

A wash nozzle assembly for comprising a cylindrical nozzle body component having a proximal end with a demountable coupling device for engaging a supply of high-speed fluid, and a distal end; a cylindrical nozzle tip component having a proximal end for demountable coupling with the distal end of the cylindrical nozzle body, and a conical distal end, said conical distal end having at least one orifice; at least one O-ring mounted onto the distal end of the cylindrical nozzle body; a swirl plate mounted into a juncture of the cylindrical nozzle body and the cylindrical nozzle tip component, the swirl plate having at least one channel therethrough; and a three-dimensional flow interrupter component housed within the cylindrical nozzle tip component. The wash nozzle assembly can be demountable engaged with an end of coiled tubing for cleaning and washing debris from a wellbore.

### TECHNICAL FIELD

This disclosure relates to wash nozzles. More specifically, this disclosure pertains to high-pressure wash nozzles for rotating fluid flows and for modulating rotational fluid flows within tubing and/or housings.

### BACKGROUND

Coil Tubing, also commonly referred to as “endless tubing”, is widely used in the oil and gas service industries for conducting many different stimulation and or work-overs of newly drilled and older producing wells. Coil Tubing generally comprises a continuously “spooled” indefinite length of tubing, usually constructed of steel although other materials have been used.

Coiled tubing is generally stored on service reels, and is deformed and straightened during deployment into the wellbore. During retrieval from a wellbore, the coil tubing is repeatedly deformed and bent out of shape as it is returned to its service reel. A coiled tubing unit is often used for repeated deployment into and retrieval from wellbores. The repeated deployment-retrieval usage produces bend-cycle fatigue stress within the tubing material. The coiled tubing material is also subject to fatigue resulting from internal pressure cycling and axial load cycling fluids pumped through and or recirculated through the tubing. Such fatigue can result in dimensional changes in the coiled tubing over time, softening of the metal material, and compromising of the coiled tubing seam welds.

Oil/gas service tools are commonly connected to coiled tubing and inserted into wellbores for downhole cleaning. Examples of such tools include wash nozzles and jetting nozzles. For example, a wash nozzle connected to the end of a coil tubing is inserted into a wellbore after which, pressurized cleaning fluid exemplified by water, acids or nitrogen, and the like, is pumped into the coil tubing and exits through the wash nozzle in the vicinity of the area to be cleaned. Such wash nozzles are commonly used to remove sand plugs, wax, calcium or debris such as failed linings from within the coiled tubing unit. Accumulations of sand plugs and/or wax and/or calcium, and/or debris significantly reduce the efficiency of the well performance. Similarly, wash nozzles can be used to clean other confined and/or tubular spaces exemplified by sewer lines, industrial waste lines, and the like.

Typical nozzles or “static” nozzles are a stationary body threaded onto the end of the coiled tubing with small ports drilled through to create a spray pattern of high energy jets of cleaning fluid. Different nozzles have different but fixed number, size and orientation of the ports. The ports are typically circular, each producing a focused linear jet. The drawback of static nozzles is that they only clean along a path where the jet streams impact the inner wall of the tubing, and they cannot provide 360 degrees of cleaning. Therefore, they cannot directly clean an entire surface of tubing or wellbore.

Rotating wash nozzles generally provide 360 degrees of cleaning to completely cover the inner wall of the tubing. These types of nozzles generally comprise a spinning end body with ports for pressurized fluid egress in a rotating pattern. Due to the speed of flow of the irrigating fluid, unconstrained rotating wash nozzles tend to spin excessively, such that the irrigation fluid is spun into a mist or fine dispersion resulting in a rapid loss of energy and consequently, not effective for cleaning wells. To address this problem, some rotating wash nozzles have incorporated speed-limiting devices into the tool so that the rotation speed generated by the egressing pressurized fluid is not excessive. Examples of rotational speed-limiting devices include the use of high-viscosity fluids, brake pads, pressure-relief valves and the like. Although these devices have been used successfully in limiting in-tube rotational speed, they are cumbersome to use, service and rebuild thereby making the tools costly to rent or purchase. Furthermore, they are vulnerable to damage. These devices do not provide any indication of how fast the tool is rotating inside the coiled tubing, and therefore, are vulnerable to in-use damage. In particular, the rotating element of such nozzles is an outer component. Furthermore, such devices can be prevented from rotating through contact with the casing wall and/or the sand plug and/or other debris. Consequently, an operator at the ground surface level has no way of knowing if the rotating wash nozzle is no longer rotating and no longer providing effective cleaning.

Other attempts to improve the performance of static or rotational wash nozzles include the use of turbulent flow tools, gas pulsing tools, and frequency generating (ultra-sonic) tools. While these devices can increase the effectiveness of the cleaning and debris removal by wash nozzle, such devices also increase the cost and complexity of the wash nozzles.

### SUMMARY

The exemplary embodiments of the present disclosure pertain to wash nozzle assemblies producing a high-speed pulsatile and intermittent fluid flow for washing debris from and cleaning wellbores, industrial fluid waste lines, municipal waste lines and the like.

An exemplary wash nozzle assembly comprises (i) a cylindrical nozzle body component having a proximal end with a demountable coupling device for engaging a supply of high-speed fluid, and a distal end, (ii) a cylindrical nozzle tip component having a proximal end for demountable coupling with the distal end of the cylindrical nozzle body, and a conical distal end, said conical distal end having at least one orifice, (iii) at least one O-ring mounted onto the distal end of the cylindrical nozzle body (iv) a swirl plate mounted into a juncture of the cylindrical nozzle body and the cylindrical nozzle tip component, the swirl plate having at least one channel therethrough; and (v) one or more three-dimensional flow interrupter components housed within the cylindrical nozzle tip component.

According to one aspect, the shape and form of the three-dimensional flow interrupter components may be spherical, rectangular bodies, and irregularly shaped asymmetrical bodies.

The exemplary wash nozzles disclosed herein can be easily serviced in the field simply by disengaging the cylindrical nozzle tip component from cylindrical nozzle body component, removing and replacing the three-dimensional flow interrupter components, and sealably re-engaging the cylindrical nozzle tip component and the cylindrical nozzle body component.

### BRIEF DESCRIPTION OF THE FIGURES

The present disclosure will be described in conjunction with reference to the following drawings in which:

FIG. 1 is an exploded perspective view of a wash nozzle assembly according to an exemplary embodiment of the present disclosure;

FIG. 2 is a cross-sectional side view of a nozzle body component 1 and O-ring components from the wash nozzle assembly shown in FIG. 1;

FIG. 3 is a cross-sectional side view of a wash nozzle tip component from the wash nozzle assembly shown in FIG. 1;

FIG. 4 is a cross-sectional side view of the wash nozzle tip component from FIG. 3, shown with installed flow interrupters;

FIG. 5 is a cross-sectional side view of the wash nozzle tip component from FIG. 4, shown with an installed swirl plate;

FIG. 6 is a cross-sectional side view of the wash nozzle tip component from FIG. 6, shown with an installed O-ring;

FIG. 7 is a cross-sectional side view of the wash nozzle assembly shown in FIG. 1;

FIG. 8 is an exploded view of a perspective view of a wash nozzle assembly according to another exemplary embodiment of the present disclosure;

FIG. 9 is a cross-sectional side view of the wash nozzle assembly from FIG. 8 showing three non-spherical flow interrupters housed in the wash nozzle tip component;

FIG. 10 is an exploded perspective view of a wash nozzle assembly according to another exemplary embodiment of the present disclosure;

FIG. 11 is a cross-sectional side view of the wash nozzle assembly from FIG. 10 showing two dissimilar flow interrupters housed in the wash nozzle tip component;

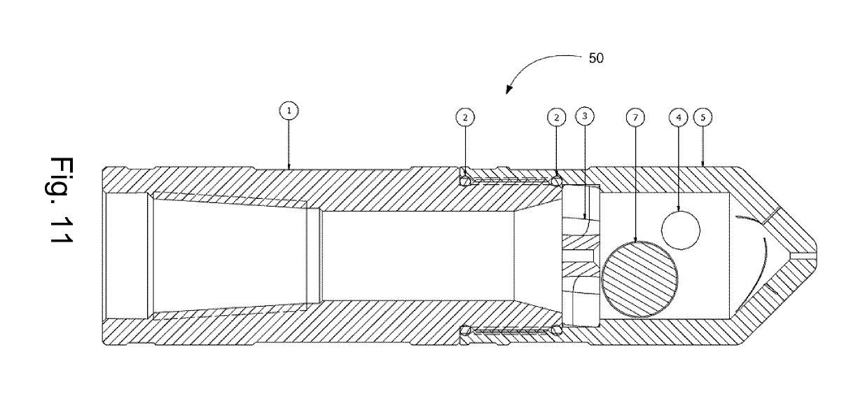

FIG. 12 is an exploded perspective view of a wash nozzle assembly according to another exemplary embodiment of the present disclosure;

FIG. 13 is a cross-sectional side view of the wash nozzle assembly from FIG. 12 showing a perforated interrupter housed in the wash nozzle tip component;

FIG. 14 is an exploded perspective view of a wash nozzle assembly according to another exemplary embodiment of the present disclosure; and

FIG. 15 is a cross-sectional side view of the wash nozzle assembly from FIG. 14 showing a piston housed in the spiral nozzle housing.

### DETAILED DESCRIPTION

The exemplary embodiments of the present disclosure generally pertain to wash nozzle assemblies for cleaning sand plugs and/or wax and/or calcium and/or other types of debris from fluid-conveying conduits exemplified by oil well casings, gas well casings, production tubing, wellbores, industrial waste fluid lines, municipal waste fluid lines, and the like.

According to some aspects, the wash nozzle assemblies disclosed herein produce overlapping laminar sheets of high-speed irrigating fluid flows projecting outward from the assemblies in a 360 degree spray pattern. The exemplary wash nozzle assemblies do not have any externally extending or positioned moving components or rotating components thereby minimizing the potential of stalling of the fluid flow due to blockage by the debris.

According to some aspects, the exemplary wash nozzle assemblies house in their tip components, one or more unrestrained flow interrupters which continuously cause intermittent asymmetrical blockages of fluid flow in areas of the nozzle assembly thereby producing an egressing fluid flow that is irregularly pulsatile and intermittent.

According to some aspects, the exemplary wash nozzle assemblies are provided with a vorticity-inducing component to cause one or more of a flow vortex, a swirl flow, and a helical flow of highly pressurized high-speed irrigation fluid within and out of the wash nozzle assemblies. It is within the scope of this disclosure for the high-speed fluid flow through the wash nozzle assemblies to concurrently induce vibration of the entire wash nozzle assemblies. Some aspects of the present disclosure relate to methods for controlling and or changing the rotation direction of high-speed fluid projected out of the wash nozzle assemblies, for example, by reconfiguring the components within the wash nozzle assemblies, or by modulating the fluid flow pressure through the wash nozzle assemblies.

The exemplary wash nozzle assemblies do not have any externally mounted fluid drive or fluid directing components, and function by modulating the rate of fluid flow into and through the wash nozzle assemblies in combination with the flow interrupter components and/or the vorticity-inducing components to controllably modulate the 360 degree high-speed outward projection of irrigating fluid from the wash nozzle assemblies into target areas within the coiled tubing. The exemplary wash nozzle assemblies direct irrigating fluid over the entire circumference of the tube or wellbore. Accordingly, the amount of deployment-recovery-repositioning cycles required to thoroughly clean a tube or well bore is considerable reduced. Furthermore, the flow interrupter components that generate the intermittent, pulsing high-speed fluid flow, reduce the volumes of water required for washing processes and the bending fatigue on the coiled tubing is reduced.

Additionally, the intermittent, pulsing high-speed fluid flow directed over the entire circumference allows the tube or wellbore to be thoroughly cleaned at lower fluid pressures and fluid flow rates than static jet wash nozzles. This reduces pressure fatigue on the coiled tubing.

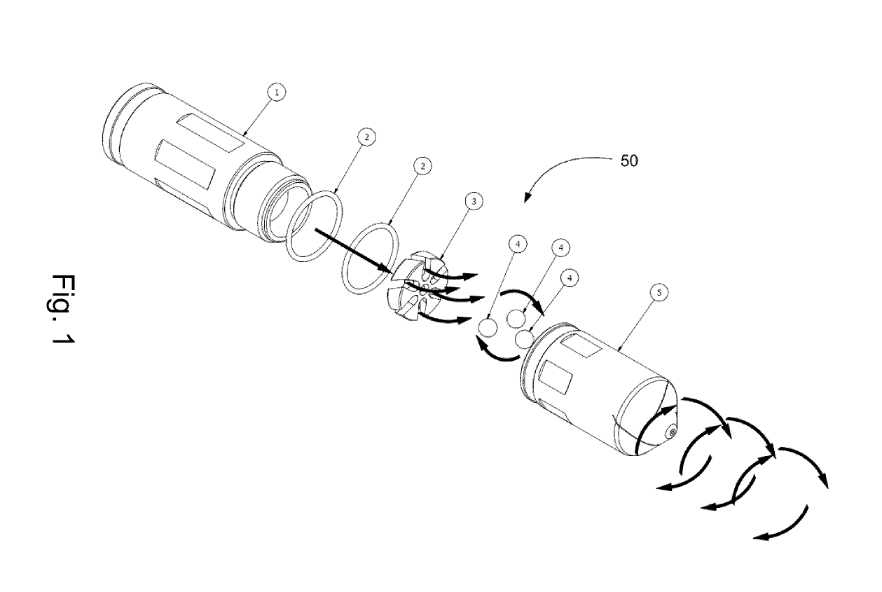

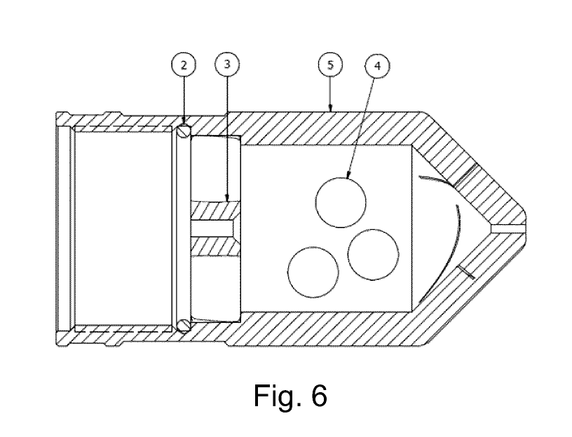

An exemplary wash nozzle assembly 50 is shown in FIGS. 1-7 and comprises a nozzle body component 1, a wash nozzle tip component 5, an O-ring 2, a swirl plate component 3, and at least one three-dimensional flow interrupter component 4.

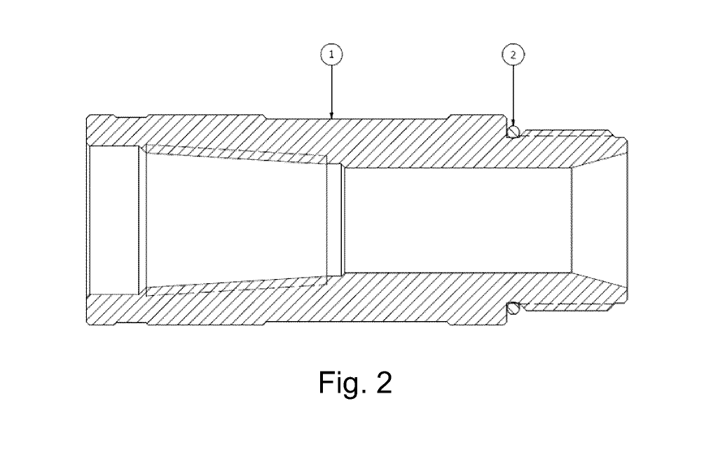

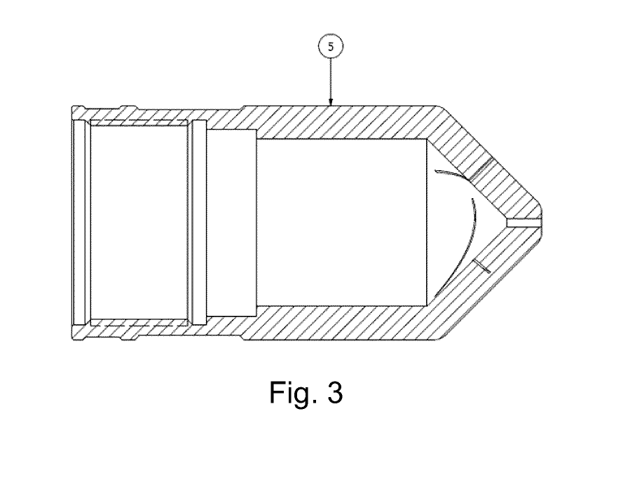

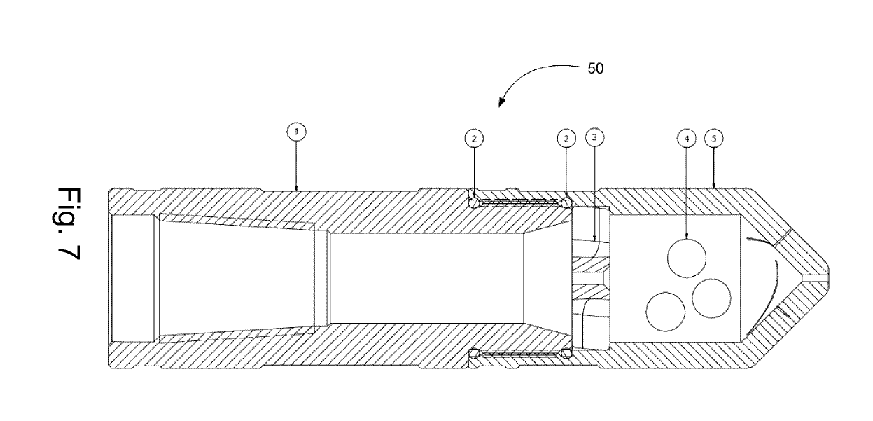

The nozzle body component 1 (FIGS. 1, 2) is an approximately cylindrical component sized to fit inside a casing of a wellbore and is configured to demountably engage the end of a fluid delivery pipe exemplified by a coiled tubing unit. This connection may involve a standard coiled tubing connector with threaded couplings or alternatively, dimpled couplings. The nozzle body component 1 has a channel through which a fluid can flow. The distal end (furthest from the surface) of the nozzle body component 1 has a threaded connection for demountably engaging the wash nozzle tip component 5 (FIGS. 1, 3). The threaded connection is isolated from the internal channel and the external space by two or more seals exemplified by O-rings 2 (FIGS. 2, 7) in thread reliefs of the nozzle body component 1 and the wash nozzle tip component 5. These prevent pressure loss and irrigation fluid loss from inside the wash nozzle assembly 50 and prevent external debris and fluid from entering the wash nozzle assembly 50, contaminating the threads and possibly damaging the tool.

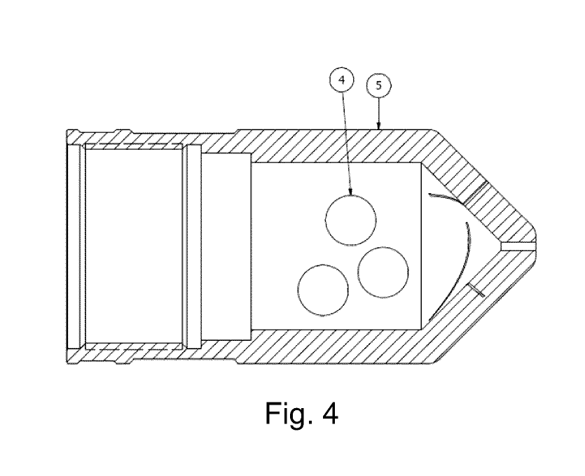

The wash nozzle tip component 5 is approximately cylindrical with a conical tip at its distal end. The wash nozzle tip component 5 has an internal chamber in which may be housed one or more flow interrupter component 4 (FIG. 4). The flow interrupter components 4 are free to move about and within the chamber of the wash nozzle tip component 5 (FIGS. 4-7). Fluid flow around the flow interrupter components 4 causes them to move about and rotate within the wash nozzle tip component 5.

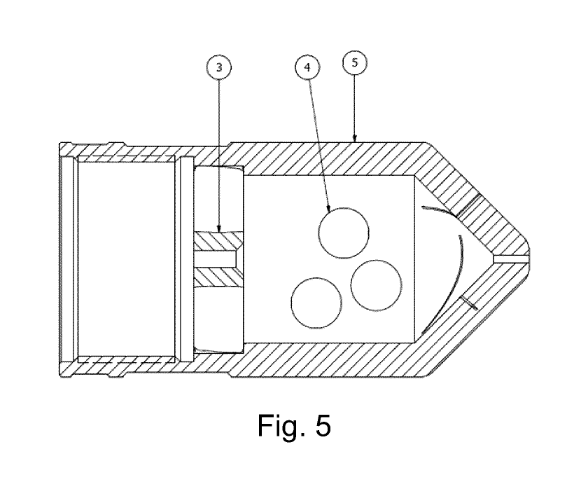

Mounted between the nozzle body component 1 and the wash nozzle tip component 5 is a swirl plate 3 (FIGS. 5-7). The swirl plate 3 is generally a shallow cylindrical plate having a plurality of channels for fluid flow therethrough. These channels “condition” the fluid flow. Preferably the channels are angled relative to the axis of the wash nozzle assembly 50 such that a vortex or fluid swirl is induced in the irrigation fluid as it passes through the swirl plate 3. Preferably the swirl plate 3 is compressed between the nozzle body component 1 and the wash nozzle tip component 5 such that frictional forces between the swirl plate 3, the nozzle body component 1, and the wash nozzle tip component 5 firmly secures the swirl plate 3 in place, and prevents it from moving or rotating. Optionally, the swirl plate 3 may be positioned between the nozzle body component 1 and the wash nozzle tip component 5, but a small clearance is provided so that the swirl plate 3 is free to rotate within the wash nozzle assembly 50. Optionally, the channels through the swirl plate 3 are parallel to the axis of the wash nozzle assembly and do not impart vorticity on fluid flow therethrough. The channels in the swirl plate 3 are smaller in diameter than the diameter of the flow interrupter components 4, such that the flow interrupter components 4 are contained within the wash nozzle tip component 5.

The end of the wash nozzle tip component 5 is conical for the purpose of centering the wash nozzle assembly 50 within the casing of the wellbore and to allow the wash nozzle tip component 5 to be impaled into a sand plug or other such debris. The wash nozzle tip component 5 is robust and tolerant of mechanical damage. The wash nozzle tip component 5 has very thin downward jetting slots machined in the conical end at multiple angles from the longitudinal axis. Additionally, the wash nozzle tip component 5 may have orifices such as a circular profile hole at the tip. Irrigation fluid exemplified by pressurized water and acid solutions, exits the wash nozzle through these jetting slots and holes. Pressurized fluid exits each of the slots in a stream shaped like a fan or sheet. This results in a forward jetting stream and a high-pressure fluid stream that is non-perpendicular to the tubing wall. The slots each cover an arc of the circumference of the wash nozzle tip component 5. Preferably, the arcs overlap such that the entire circumference of the wash nozzle tip component 5 produces a plurality of laminar fluid sheets. For example, there may be three slots equally spaced around the circumference and each covering an arc of greater than 120 degrees of the circumference. Preferably the slots are angled to the longitudinal axis of the wash nozzle such that a vortex of fluid is generated as the fluid exits the wash nozzle. Optionally, the slots are angled to induce rotation in the fluid in the same direction as the swirl plate 3. Optionally, the slots are angled to optimize the vortex generation, for example by angling at 45 degrees to the longitudinal axis of the wash nozzle with similarly oriented 45 degree channels in the swirl plate 3. Preferably the fluid is spun in a counter clockwise rotation as to prevent the nozzle from unthreading from the nozzle body component 1. The fluid vortex generated outside the wash nozzle and inside the tubing aids in well cleaning as debris removed from the tubing wall impacts remaining debris.

The flow interrupter components 4 are moved within the wash nozzle tip component 5 by the fluid flow and will occasionally block the inner extent of the wash nozzle tip component 5 slots. This briefly reduces or stops the fluid flow exiting the wash nozzle in that region. Therefore the fluid flow exiting the wash nozzle at a particular point is pulsatile or intermittent. This aids in dislodging sand or debris by varying the force of the fluid stream that impacts any particular area of sand or debris. The flow interrupter components 4 may be spherical within a smooth chamber in the wash nozzle tip component 5, such that the flow interrupter components 4 move with a predominantly smooth, constant rotation speed and the resulting fluid stream from the wash nozzle has a regular, periodic variation. For example, the flow interrupter components 4 may be ball bearings or alternatively, be made from plastic.

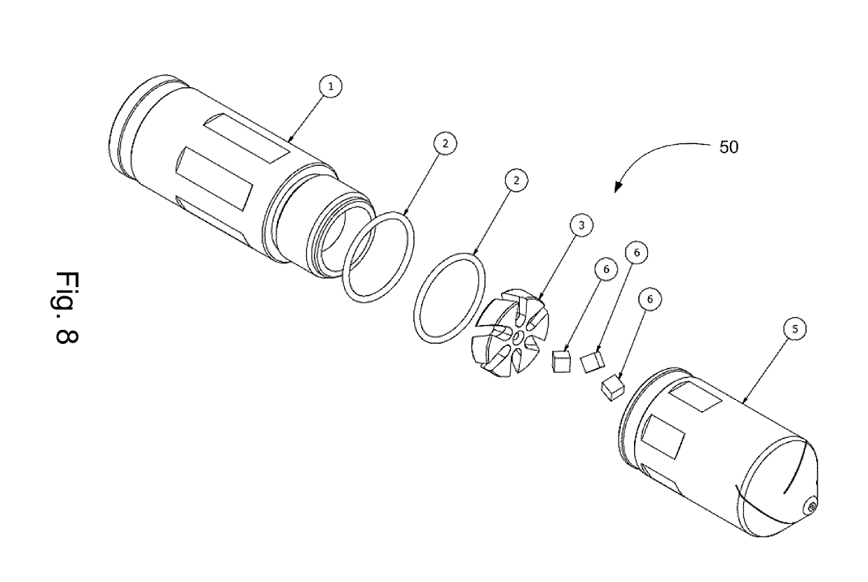

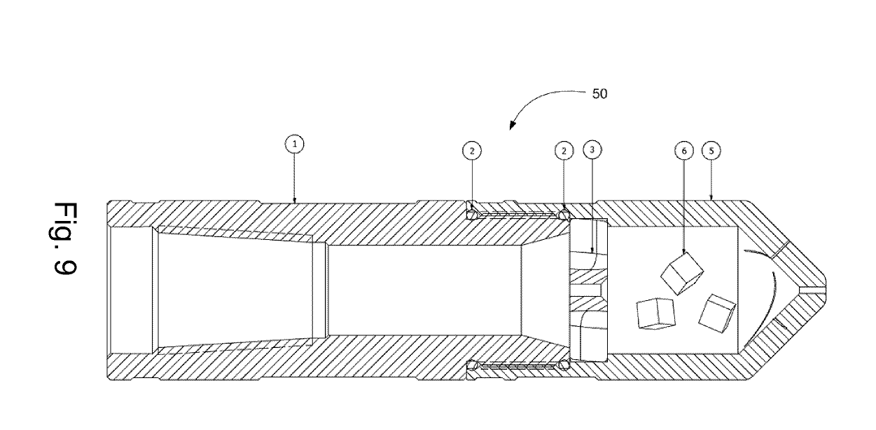

In some applications, it may be preferred that fluid stream from the wash nozzle is random or aperiodic and covers a broad range of periodic frequencies. This may be preferred to reduce standing waves or to induce resonance in the debris with a broad range of frequencies. As exemplified in FIGS. 8 and 9, the shapes of the flow interrupter components 6 may be non-spherical, for example cubic as shown in FIGS. 8 and 9. Alternatively, the flow interrupter components may be any form or combination of three-dimensional rectilinear bodies such as exemplified by cubes, tetrahedrons, bisphenoids, parallelepipeds, prisms, pyramids, frustrums, and the like. Alternatively, the inner surface of the wash nozzle tip component 5 may be irregular or elliptical so that the movement of the flow interrupter components within the wash nozzle tip component 5 is random.

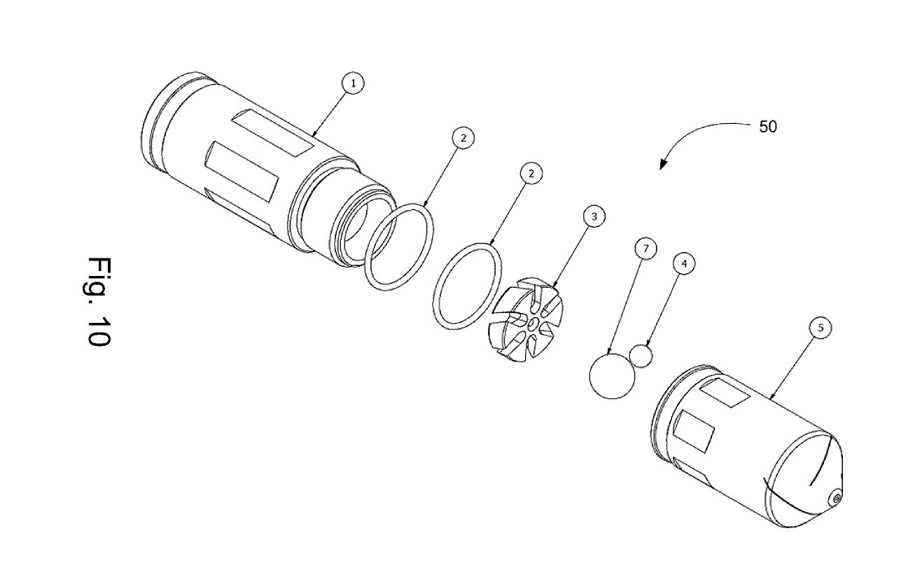

Alternatively, as exemplified in FIGS. 9 and 10, two or more flow interrupter components may be provided, each being a different size or shape or density or weight, for example, (components shown as items 4, 7). As these flow interrupter components 4, 7 spin within the wash nozzle tip component 5, the spinning eccentric weights causes the entire wash nozzle assembly 50 to vibrate. This vibration of the entire wash nozzle assembly 50 assists in dislodging debris or alternatively impaling and progressing the washing nozzle assembly 50 through softer debris such as sand.

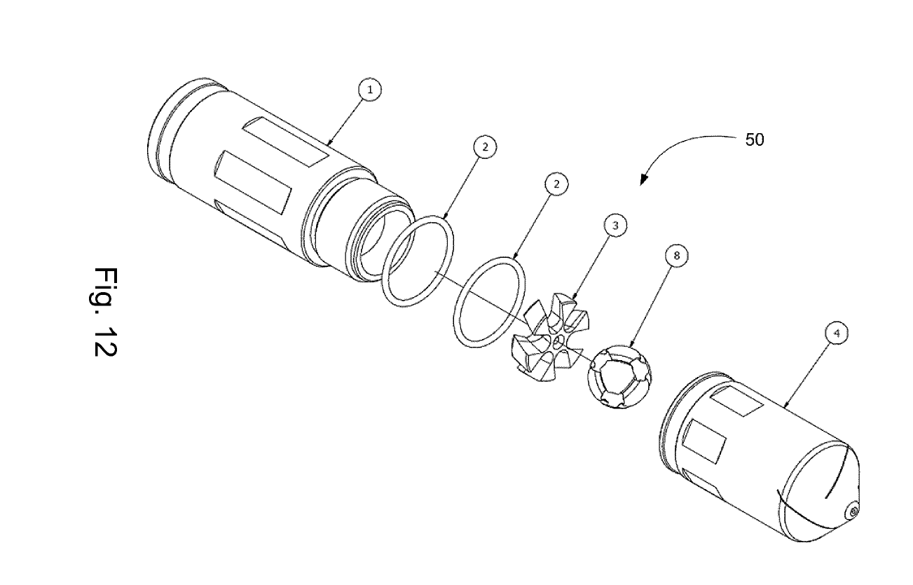

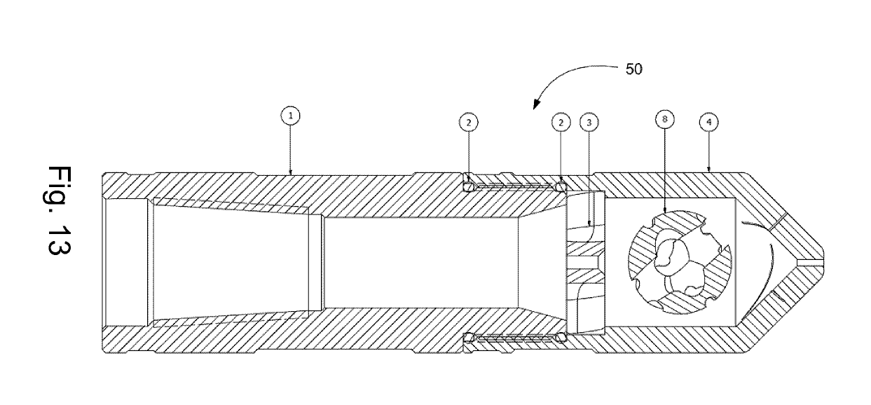

Alternatively, as shown in FIGS. 12 and 13, the flow interrupter component 8 may be a single perforated sphere 8. The perforated sphere 8 has through holes and surface grooves, similar to “wiffle balls”. A fluid flow will cause the perforated sphere to spin about and within the wash nozzle tip component 5 as fluid passes through and around the sphere 8, thereby modulating the high pressure fluid flow exiting the wash nozzle.

Once assembled, the exemplary wash nozzle assembly 50 is installed onto a coiled tubing connector already attached to the coiled tubing, and is inserted into the casing of a wellbore. The device is lowered or pushed by the coiled tubing to the vicinity of the region of the wellbore to be cleaned. Irrigation fluid or cleaning fluid such as pressurized water, acid or nitrogen is pumped through the coiled tubing and enters the wash nozzle through the nozzle body component 1. The fluid is spun in a counter clockwise rotation as to prevent the wash nozzle tip component 5 from unthreading from the nozzle body component 1. As the flow interrupter components are spun inside the wash nozzle tip component 5 and momentarily block the flow from exiting the wash nozzle tip component 5. The result is a pulsated jet stream with random frequencies which will also aid in the cleaning operation. O-rings 2 are placed in the thread reliefs of the nozzle body component 1 and the wash nozzle tip component 5 to prevent the removed well debris from contaminating the threads and possibly damaging the tool.

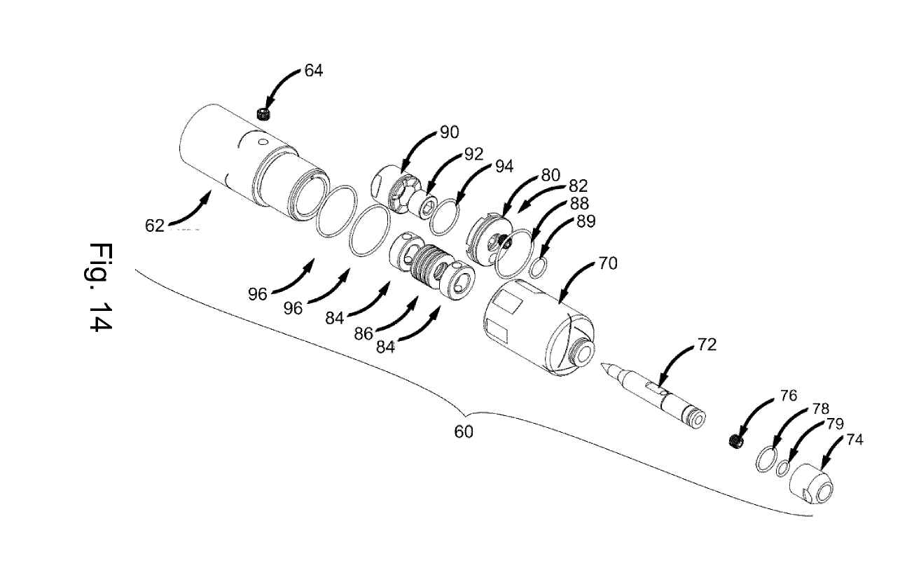

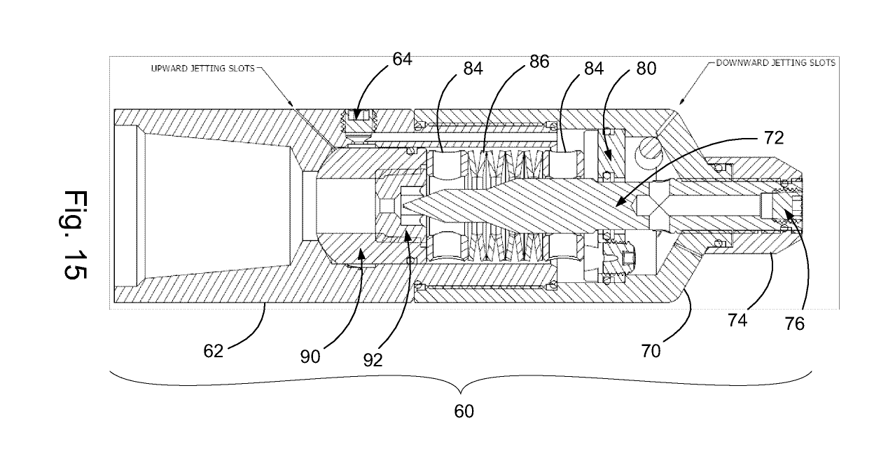

Another embodiment of wash nozzle assembly 60 according to this disclosure is shown on FIGS. 14 and 15. This wash nozzle assembly 60 comprises a top sub spiral nozzle 26 with a plurality of upward jetting slots (FIG. 15). The wash nozzle assembly 60 is sealably engaged with the proximal end of a spiral nozzle housing 70 by O-rings 96. A swirl plate 80 with a ported hex plug 82 is sealingly engaged within the spiral nozzle housing 70 by an O-ring. Within the top sub spiral nozzle 26 is housed a piston 90 with which is engaged a hex plug 92. Abutting the hex plug 92/piston 90 is a first spring spacer 84, and a second spring spacer 86. A valve stem 72 is inserted into an orifice provided therefor at the distal end of the spiral nozzle housing 70 until it abuts the hex plug 92 engaged with the piston 90. An O-ring 89 interposed the inner orifice of the swirl plate 80 and the valve stem 72 enables leak-proof sliding communication of the valve stem 72 and the swirl plate 80. The valve stem 72 is sealingly secured in place within the wash nozzle assembly 60 with hex plug 76, O-rings 78, 79, and lock nut 74. In operation, the piston 90 functions as an internal shifting mechanism to allow an operator to select the direction that high-pressure fluids to be jetted either downward or upward. As shown in FIG. 15, the piston 90 is held in a normally closed position via the spring stack 84, 86, 84. Then the piston 90 is in a closed position, high-pressure fluid flows through the wash nozzle assembly 60 and out of the downward jetting slots (shown in FIG. 15). When enough pressure is built up in the nozzle (which is operator controlled), the spring force associated with the spring stack 84, 86, 84 is overcome by the piston force and the piston 90 is shifted up against the valve stem 72 thereby shutting off high-pressure fluid flow through the downward jets and subsequently re-directing the high-pressure fluid flow through the rear upward jetting slots.

The exemplary flow interrupter components are field-serviceable and the wash nozzle tip component 5 can be unthreaded to remove the flow interrupter components and to insert replacement flow interrupter components. This can be used to change the characteristics of the fluid flow, for example by switching from periodic to random pulses, or by adding or removing vibration of the wash nozzle.

There may be cases where the flow interrupter components are not available or are lost or are damaged. In these cases, the flow interrupter components can be replaced in the field with any objects that can be placed inside the wash nozzle and spun in the fluid flow. For example, suitable objects include ball bearings, nuts, players dice, or small rocks. If the flow interrupter components fail to spin inside the wash nozzle. The flow will still result in a generated vortex below the tool in the tubing. It is also to be noted that non-similar-sized flow interrupter components and/or flow interrupter components having different densities will create an unbalanced rotation which will help aid progressing the tools through softer debris such as sand.

Since coiled tubing is manufactured in many different sizes ranging from 0.5″ to 5″ outside diameter, it is preferable for coiled tubing tools to have a similar same diameter as the coiled tubing within which they are to be deployed. The common use of any particular size is also based on “supply/demand” by the service providers' clients. The most commonly used sizes of coiled tubing and tools are exemplified by: (i) minimum 1.25″ Outside Diameter, (ii) maximum 3.25″ Outside Diameter, and (iii) particularly suitable is arrange from about 1.5″ to about 2.875″ Outside Diameter. While any type of material can be used to construct the exemplary wash nozzle assemblies disclosed herein, the following material “Yield Tensile Strength” (YTS) are particularly suitable:

Nozzle body component:
Min Yield Tensile Strength (30,000 psi)
Max Yield Tensile Strength (unlimited to material development)
Preferred/Common Yield Tensile Strength (95,000 psi)

Wash nozzle tip component:
Min Yield Tensile Strength (30,000 psi)
Max Yield Tensile Strength (unlimited to material development)
Preferred/Common Yield Tensile Strength (95,000 psi)

O-rings:
VITON® 75 Durometer (VITON is a registered trademark of Lautsprecher Teufel GmbH, Berlin, Fed. Rep. Germany)

Swirl plate component:
Min Yield Tensile Strength (30,000 psi)
Max Yield Tensile Strength (unlimited to material development)
Preferred/Common Yield Tensile Strength (95,000 psi)

Flow interrupter components
Stainless Steel 304/316
UHMW, PTFE

It is within the scope of the present disclosure to incorporate additional features into the exemplary wash nozzle assemblies disclosed herein. For example, the swirl plate component may be designed to rotate within the nozzle body component during fluid flow therethrough to facilitate a pulsated flow egressing from the wash nozzle tip component. Another example is to provide a second swirl plate within the wash nozzle assembly that is spaced-apart from the first swirl plate, wherein the second swirl plate has one or more channels angled to induce a clockwise rotation of the cleaning fluid plus one or more channels angled to induce a counter-clockwise rotation of the cleaning fluid. The reversing swirl plate will rotate about the longitudinal axis by, for example, 90 degrees every time a fluid pressure is applied.

1. A wash nozzle assembly comprising:
a cylindrical nozzle body component having a proximal end with a demountable coupling device for engaging a supply of high-speed fluid, and a distal end;
a cylindrical nozzle tip component having a proximal end for demountable coupling with the distal end of the cylindrical nozzle body, and a conical distal end, said conical distal end having a plurality of downward jetting slots;
at least one O-ring mounted onto the distal end of the cylindrical nozzle body;
a swirl plate mounted into a juncture of the cylindrical nozzle body and the cylindrical nozzle tip component, the swirl plate having at least one channel therethrough; and
a three-dimensional flow interrupter component housed within the cylindrical nozzle tip component.

2. A wash nozzle assembly according to claim 1, wherein the distal end of the cylindrical nozzle tip component as a plurality of orifices therethrough.

3. A wash nozzle assembly according to claim 1, wherein the orifice in the distal end the cylindrical nozzle tip component is elongate in the form of a slot.

4. A wash nozzle assembly according to claim 1, wherein the three dimensional flow interrupter component is in the form of a sphere or an elliptical body.

5. A wash nozzle assembly according to claim 1, wherein the three dimensional flow interrupter component is in the form of a cube, a tetrahedron, a bisphenoid, a parallelepiped, a prism, a pyramid, a frustrum.

6. A wash nozzle assembly according to claim 1, wherein the three dimensional flow interrupter component has an irregular form.

7. A wash nozzle assembly according to claim 1, comprising two or more three dimensional flow interrupter components housed within the cylindrical nozzle tip component.

8. A wash nozzle assembly according to claim 7, wherein at least one three dimensional flow interrupter components has a smaller form or a heavier form or a denser form.

9. A wash nozzle assembly according to claim 1, wherein the cylindrical nozzle body component has a plurality of upward jetting slots and the the wash nozzle assembly additionally comprises:
a piston slidingly housed within the cylindrical nozzle body component;
a spring stack interposed the piston and the swirl plate, said spring stack comprising a first spring spacer, a spring, and a second spring spacer;
a valve stem abutting the piston and slidingly communicable through a orifice provided therefor in the swirl plate;
whereby when the piston is in a closed position, a high-pressure fluid flow is directed toward the downward jetting slots in the cylindrical nozzle tip component, and when the piston is in an open position, the high-pressure fluid flow is directed toward the upward jetting slots in the cylindrical nozzle body component.

10. A wash nozzle assembly according to claim 1, wherein the supply of high-speed fluid is delivered through a coiled tubing.
